(19) United States
(12) Patent Application Publication
(10) Pub. No.: US 2015/0212702 A1
(43) Pub. Date: Jul. 30, 2015

(54) MOBILE TERMINAL AND METHOD OF CONTROLLING THE SAME

(71) Applicant: LG ELECTRONICS INC., Seoul (KR)

(72) Inventors: Mina KIM, Seoul (KR); Yunae NAM, Seoul (KR); Junggon KIM, Seoul (KR); Hosung SONG, Seoul (KR)

(73) Assignee: LG ELECTRONICS INC., Seoul (KR)

(21) Appl. No.: 14/516,329

(22) Filed: Oct. 16, 2014

(30) Foreign Application Priority Data
Jan. 29, 2014 (KR) 10-2014-0011718

(51) Int. Cl. G06F 3/0484; G06F 3/0481; G06F 3/0482

(52) U.S. Cl. CPC G06F 3/04842; G06F 3/0482; G06F 3/04817

(57) ABSTRACT

A mobile terminal including a wireless communication unit configured to provide wireless communication, a display unit configured to display a folder including multiple images and a controller configured to receive a touch input having a specific pattern applied to the folder and display images present within the folder on the folder according to a predetermined display pattern associated with the touch input applied to the folder is provided.

### CROSS-REFERENCE TO RELATED APPLICATION

Pursuant to 35 U.S.C. §119(a), this application claims the benefit of earlier filing date and right of priority to Korean Application No. 10-2014-0011718, filed on Jan. 29, 2014, the contents of which is incorporated by reference herein in its entirety.

### BACKGROUND OF THE INVENTION

1. Field of the Invention

The present technology disclosed in the present specification relates to a mobile terminal and a method of controlling the mobile terminal

2. Background of the Invention

Generally, a mobile terminal (portable electronic apparatus) is a portable apparatus that is equipped with at least one or more among a voice and image communication call function, an information output and input function, and a data storage function. In addition, in response to an increasing demand for diversified functions, the mobile terminal has been realized in the form of a multimedia player with multiple functions (for example, as photographing a photographic subject as a still image or a moving image, reproducing digital audio and video compression files, playing a game, receiving a broadcast or the like).

### SUMMARY OF THE INVENTION

Therefore, an aspect of the detailed description is to provide a mobile terminal that is capable of effectively displaying images present within a folder on the folder and a method of controlling the mobile terminal.

To achieve these and other advantages and in accordance with the purpose of this specification, as embodied and broadly described herein, there is provided a mobile terminal including a wireless communication unit configured to provide wireless communication, a display unit configured to display a folder including multiple images and a controller configured to receive a touch input having a specific pattern applied to the folder and display images present within the folder on the folder according to a predetermined display pattern associated with the touch input applied to the folder.

In the mobile terminal, the controller may successively display the images present within the folder on a screen of the display unit only while the touch input is sensed as being applied to the folder, and the successively arranged images may be gradually enlarged and then be gradually reduced.

In the mobile terminal, the controller may enlarge the folder while the touch input is applied to the folder for a predetermined time and may sequentially display the images present within the folder on the folder each time the touch input is sensed as being applied to the enlarged folder.

In the mobile terminal, the controller may pile up the images present within the folder one on top of another on the folder when the touch input is sensed as being applied to the folder, and when a touch input in a specific pattern or a gesture is sensed as being applied to the piled-up images, the controller may arrange the piled-up images in a direction in which the touch input in the specific pattern or the gesture is applied to the piled-up images and may move the arranged piled-up images.

The mobile terminal may further include a sensing unit that senses a user's gaze, in which the controller may change inclinations of the images arranged on the folder so the images displayed on the folder are matched with the user's gaze. In the mobile terminal, each of the images may be a thumbnail image, and the controller may recognize a human face or a human contour present in each photograph present within the folder, may cut each photograph into a predetermined size based on the human face or the human contour that is recognized, and thus may generate the thumbnail image.

In the mobile terminal, each of the images may be a thumbnail image, and the controller may recognize a human face or a human contour present in each photograph present within the folder, may enlarge an area corresponding to the human face or the human contour that is recognized, and thus may generate the enlarged region as the thumbnail image.

In the mobile terminal, when the images present within the folder are sequentially displayed on the folder, if the images, each having a same or similar object, are recognized as being present within the folder, the controller may determine the recognized images as one group, may display only one image selected from the one group on the folder, and then may sequentially display on the folder the images that appear after the one group.

In the mobile terminal, the controller may display a scroll bar on the folder, and may sequentially display the images present within the folder on the folder as the scroll bar is scrolled.

In the mobile terminal, the controller may display information indicating turn of the image currently displayed on the folder, on the scroll bar.

In the mobile terminal, when the touch input in the specific pattern is sensed as being applied to the folder, the controller may sequentially display the images present within the folder on the folder and at the same time, may automatically display images present sequentially within a folder adjacent to the folder on the adjacent folder.

In the mobile terminal, if the touch input in the specific pattern is sensed as being applied to the folder, when the images within the folder are sequentially displayed on the folder, the controller may search the images present within the adjacent folder for an image that is matched to or similar to the image currently displayed on the folder.

In the mobile terminal, if the images present within the folder are sequentially are displayed on the folder each time the touch input in the specific pattern is sensed as being applied to the folder, the controller may arrange adjacent folders in order of decreasing the number of person images each of which is matched to or similar to the image currently displayed on the folder and may display the arranged adjacent folders.

In the mobile terminal, the controller may arrange first adjacent folders each of which includes an image that is matched to or similar to the image currently displayed on the folder, among folders adjacent to the folder, so the first adjacent folders are adjacent to the folder, and at the same time, may enlarge the first adjacent folders and may reduce second adjacent folders each of which includes an image that is non-matched or non-similar to the image concurrently displayed on the folder.

In the mobile terminal, when a first image is captured by a first camera, the controller may search the folder for the first images captured by the first camera, and may display the searched-for first images on the display unit along with the captured first image. Then, when a second image is captured by a second camera, the controller may search the folder for the second images captured by the second camera, and may display the searched-for second images on the display unit along the captured second image. Then, the first camera and the second camera may be different from each other.

In the mobile terminal, when a specific shape is drawn with the touch input in the specific pattern, the controller may change a shape of the specific image into the specific shape, and may display the image in the changed shape as a thumbnail image.

In the mobile terminal, the controller may search the folder for images that are matched to the specific image, and may automatically change shapes of the searched-for images into the specific shape.

In the mobile terminal, when the touch input in the specific pattern is sensed as being applied to the folder, the controller may execute a web application program, may search for an image associated with the image currently displayed on the folder through the web application program, and may display the searched-for image along with the currently displayed image.

In the mobile terminal, when the images present within the folder are displayed on the folder, if the image currently displayed on the folder is a panoramic image, the controller may display on the currently displayed image a sub-image indicating that the currently displayed image is the panoramic image.

In the mobile terminal, when the sub-image is selected, the controller may display one portion of the panoramic image, which is covered by the sub-image.

In the mobile terminal, the controller may capture a first image using a first camera and at the same time may capture a second image using a second camera, may combine the first and second images captured at the same time into one image, and may display the one image that results from the combination, on the display unit. Then, each time the displayed one image that results from the combination is reduced, the controller may make a scale-down ratio of the first image present in the one image resulting from the combination differ from that of the second image, and the first camera and the second camera may be different from each other.

In the mobile terminal, when the images present within the folder are displayed on the folder, if the folder is searched for successively captured images, the controller may select a representative image from among the successively captured images and may display only the representative image on the folder.

In the mobile terminal, the controller may successively display the successively captured images on the representative image so a moving image is displayed on the representative image.

In the mobile terminal, when the representative image is selected, the controller may arrange the successively captured images in a horizontal or vertical direction, may display the arranged images, detects spatial differences between the arranged images, and may display information indicating the detected spatial difference on each of the arranged images.

In a mobile terminal and a method of controlling the mobile terminal according to embodiments of the present invention, images present within a folder are effectively displayed on the folder according to a predetermined pattern. In the mobile terminal and the method of controlling the mobile terminal according to the embodiments of the present invention, inclinations of the images displayed on the folder are changed so the images displayed on the folder are matched to a user's gaze. As a result, the user can conveniently check the images displayed on the folder.

In the mobile terminal and the method of controlling the mobile terminal according to the embodiments of the present invention, a photograph is cut into a predetermined size based on a human face or a human contour in the photograph present within the folder, and thus a thumbnail image is generated. As a result, the user can easily check whether or not the thumbnail image is a photograph of a person.

In the mobile terminal and the method of controlling the mobile terminal according to the embodiments of the present invention, the images present within the folder are sequentially displayed on the folder and at the same time, images present within a folder adjacent to the folder are on the adjacent folder in an automatic, sequential manner. As a result, the user can check the images present within the multiple folders by selecting only one folder.

In the mobile terminal and the method of controlling the mobile terminal according to the embodiments of the present invention, when a touch input in a specific pattern is sensed as being applied to the folder, an image associated with the image currently displayed on the folder is searched for through a web application program, and the searched-for image is displayed along with the currently displayed image. As a result, the multiple images associated the image currently displayed on the folder are provided.

In the mobile terminal and the method of controlling the mobile terminal according to the embodiments of the present invention, when the images present within the folder are displayed on the folder, an representative image is selected from among the successively captured images and only the representative image is displayed on the folder. As a result, the user can check what kind of image the successively captured image is, only with the representative image, without checking the successively captured images one by one.

In the mobile terminal and the method of controlling the mobile terminal according to the embodiments of the present invention, spatial differences between the images are detected and information indicating each of the detected spatial differences is displayed on each of the images. As a result, the user can easily check the difference between the images.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate embodiments and together with the description serve to explain the principles of the invention.

In the drawings:

FIG. 1A is a block diagram illustrating describing a mobile terminal according to an embodiment of the present invention;

FIGS. 1B and 1C are diagram illustrating the mobile terminal according to an embodiment of the present invention, when viewed from different directions;

FIG. 2 is a flow chart illustrating a method of controlling the mobile terminal according to the embodiment of the present invention; and

FIGS. 3 to 19(c) are diagrams illustrating methods of displaying the content (for example, the thumbnail images corresponding to the photographs) according to the embodiments of the present invention.

### DETAILED DESCRIPTION OF THE INVENTION

Description will now be given in detail according to embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present invention, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present invention should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

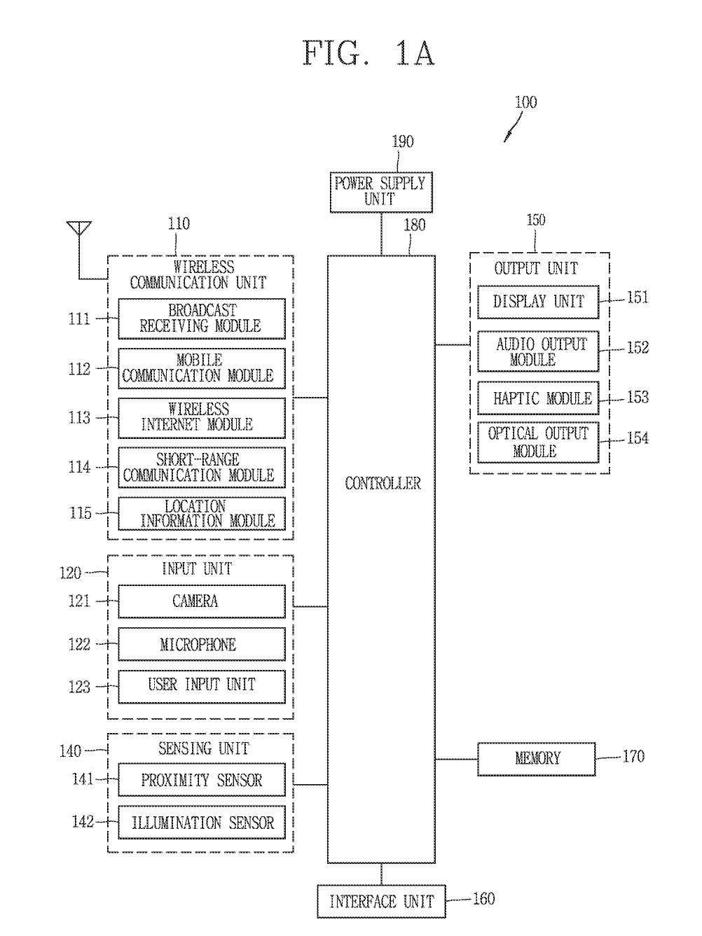

Reference is now made to FIGS. 1A-1C, where FIG. 1A is a block diagram of a mobile terminal in accordance with the present invention, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server.

Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 can provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least some of the above components may operate in a cooperating manner, so as to implement an operation or a control method of a glass type terminal according to various embodiments to be explained later. The operation or the control method of the glass type terminal may be implemented on the glass type terminal by driving at least one application program stored in the memory 170.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal combined with a TV or radio broadcast signal.

The broadcast signal may be encoded based on at least one of standards (or broadcast types, e.g., ISO, IEC, DVB, ATSC, etc.) for transceiving digital broadcasting signals. The broadcast receiving module 111 may receive the digital broadcast signal using a method suitable for the standards.

The broadcast associated information may refer to information associated with a broadcast channel, a broadcast program or a broadcast service provider. The broadcast associated information may also be provided via a mobile communication network. In this instance, the broadcast associated information may be received by the mobile communication module 112.

The broadcast associated information may exist in various forms. For example, it may exist in the form of an electronic program guide (EPG) of digital multimedia broadcasting (DMB), electronic service guide (ESG) of digital video broadcast-handheld (DVB-H), and the like. Broadcast signals and/or broadcast-associated information received via the broadcast receiving module 111 may be stored in the memory 160.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which can exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. Further, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this instance, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 can sense which region of the display unit 151 has been touched. Here, the touch controller may be a component separate from the controller 180, the controller 180, and combinations thereof.

In some embodiments, the controller 180 can execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor. Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like. A signal output by the optical output module 154 may be implemented so the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 can typically control the general operations of the mobile terminal 100. For example, the controller 180 can set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various embodiments disclosed herein.

The power supply unit 190 receives external power or provides internal power and supply the appropriate power required for operating respective elements and components included in the mobile terminal 100. The power supply unit 190 may include a battery, which is typically rechargeable or be detachably coupled to the terminal body for charging. The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance. Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like. As an alternative to the example in which the plurality of cases form an inner space for accommodating components, the mobile terminal 100 may be configured such that one case forms the inner space. In this example, a mobile terminal 100 having a uni-body is formed so synthetic resin or metal extends from a side surface to a rear surface.

If desired, the mobile terminal 100 may include a waterproofing unit for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include the display unit 151, the first audio output module 152a, the second audio output module 152b, the proximity sensor 141, the illumination sensor 142, the optical output module 154, the first camera 121a, the second camera 121b, the first manipulation unit 123a, the second manipulation unit 123b, the microphone 122, the interface unit 160, etc.

Hereinafter, the mobile terminal 100 will be explained with reference to FIGS. 1B and 1C. The display unit 151, the first audio output module 152a, the proximity sensor 141, the illumination sensor 142, the optical output module 154, the first camera 121a and the first manipulation unit 123a are arranged on the front surface of the terminal body. The second manipulation unit 123b, the microphone 122 and the interface unit 160 are arranged on the side surfaces of the terminal body. The second audio output module 152b and the second camera 121b are arranged on the rear surface of the terminal body.

However, it is to be understood that alternative arrangements are possible and within the teachings of the instant invention. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. For example, the display unit 151 may display information on an execution screen of an application program driven in the mobile terminal 100, or a User Interface (UI) or a Graphic User Interface (GUI) associated with such execution screen information.

The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output unit 152a may be implemented as a receiver for transmitting a call sound to a user's ears, and the second audio output unit 152b may be implemented as a loud speaker for outputting each type of alarm sounds or a play sound of multimedia. It may be configured such that the sounds generated from the first audio output module 152a are released along an assembly gap between the structural bodies (e.g., between the window 151a and the front case 101). In this instance, a hole independently formed to output audio sounds may not be seen or hidden in terms of appearance, thereby further simplifying the appearance of the mobile terminal 100.

The optical output module 154 can output a signal for indicating an event generation using light of a light source. Examples of events generated in the mobile terminal 100 may include message reception, call signal reception, a missed call, an alarm, a schedule notice, an email reception, information reception through an application, and the like. A signal output by the optical output module 154 may be implemented so the mobile terminal emits monochromatic light or light with a plurality of colors. The signal output may be terminated as the mobile terminal senses that a user has checked the generated event, for example.

The first camera 121a processes image data of still pictures or video acquired by an image capture device in a video capturing mode or an image capturing mode. The processed image frames may be displayed on the display unit 151, or may be stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may be implemented in a user's non-tactile manner, e.g., by a proximity touch, a hovering touch, etc.

FIG. 1B illustrates the first manipulation unit 123a as a touch key, but possible alternatives include a mechanical key, a push key, a touch key, and combinations thereof. Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject. As shown in FIG. 1C, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 (refer to FIG. 1A) may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Hereinafter, a communication system which is operable with the mobile terminal 100 according to the present invention will be described. Such communication systems utilize different air interfaces and/or physical layers. Examples of such air interfaces utilized by the communication systems include Frequency Division Multiple Access (FDMA), Time Division Multiple Access (TDMA), Code Division Multiple Access (CDMA), and Universal Mobile Telecommunications System (UMTS), the Long Term Evolution (LTE) of the UMTS, the Global System for Mobile Communications (GSM), and the like. By way of non-limiting example only, further description will relate to a CDMA communication system, but such teachings apply equally to other system types including the CDMA wireless communication system.

A CDMA wireless communication system is shown having a plurality of mobile terminals 100, a plurality of base stations (BSs), base station controllers (BSCs), and a mobile switching center (MSC). The MSC is configured to interface with a conventional Public Switch Telephone Network (PSTN). The MSC is also configured to interface with the BSCs. The BSCs are coupled to the base stations via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs can be included in the system.

Each base station may include one or more sectors, each sector having an omni-directional antenna or an antenna pointed in a particular direction radially away from the base station. Alternatively, each sector may include two or more different antennas. Each base station may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In some cases, the term “base station” may be used to refer collectively to a BSC, and one or more base stations. The base stations may also be denoted as “cell sites.” Alternatively, individual sectors of a given base station may be referred to as cell sites.

A broadcasting transmitter (BT) transmits a broadcast signal to the mobile terminals 100 operating within the system. The broadcast receiving module 111 (FIG. 1A) is typically configured inside the mobile terminal 100 to receive broadcast signals transmitted by the BT.

Global Positioning System (GPS) satellites 300 facilitate locating the position of at least one of plural mobile terminals 100. Useful position information may be obtained with greater or fewer satellites than two satellites. It is to be appreciated that other types of position detection technology, (i.e., location technology that may be used in addition to or instead of GPS location technology) may alternatively be implemented. If desired, at least one of the GPS satellites 300 may alternatively or additionally be configured to provide satellite DMB transmissions.

The location information module 115 is generally configured to detect, calculate, or otherwise identify a position of the mobile terminal. As an example, the location information module 115 may include a Global Position System (GPS) module, a Wi-Fi module, or both. If desired, the location information module 115 may alternatively or additionally function with any of the other modules of the wireless communication unit 110 to obtain data related to the position of the mobile terminal.

A typical GPS module 115 can measure an accurate time and distance from three or more satellites, and accurately calculate a current location of the mobile terminal according to trigonometry based on the measured time and distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites.

Furthermore, the GPS module can acquire speed information in real time to calculate a current position. Sometimes, accuracy of a measured position may be compromised when the mobile terminal is located in a blind spot of satellite signals, such as being located in an indoor space. In order to minimize the effect of such blind spots, an alternative or supplemental location technique, such as Wi-Fi Positioning System (WPS), may be utilized.

The Wi-Fi positioning system (WPS) refers to a location determination technology based on a wireless local area network (WLAN) using Wi-Fi as a technology for tracking the location of the mobile terminal 100. This technology typically includes the use of a Wi-Fi module in the mobile terminal 100 and a wireless access point for communicating with the Wi-Fi module. The Wi-Fi positioning system may include a Wi-Fi location determination server, a mobile terminal, a wireless access point (AP) connected to the mobile terminal, and a database stored with wireless AP information.

The mobile terminal connected to the wireless AP may transmit a location information request message to the Wi-Fi location determination server. The Wi-Fi location determination server extracts the information of the wireless AP connected to the mobile terminal 100, based on the location information request message (or signal) of the mobile terminal 100. The information of the wireless AP may be transmitted to the Wi-Fi location determination server through the mobile terminal 100, or may be transmitted to the Wi-Fi location determination server from the wireless AP.

The information of the wireless AP extracted based on the location information request message of the mobile terminal 100 may include one or more of media access control (MAC) address, service set identification (SSID), received signal strength indicator (RSSI), reference signal received Power (RSRP), reference signal received quality (RSRQ), channel information, privacy, network type, signal strength, noise strength, and the like.

The Wi-Fi location determination server may receive the information of the wireless AP connected to the mobile terminal 100 as described above, and may extract wireless AP information corresponding to the wireless AP connected to the mobile terminal from the pre-established database. The information of any wireless APs stored in the database may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like. In order to remove wireless APs provided using a mobile AP or an illegal MAC address during a location determining process, the Wi-Fi location determination server may extract only a predetermined number of wireless AP information in order of high RSSI.

Then, the Wi-Fi location determination server may extract (analyze) location information of the mobile terminal 100 using at least one wireless AP information extracted from the database. A method for extracting (analyzing) location information of the mobile terminal 100 may include a Cell-ID method, a fingerprint method, a trigonometry method, a landmark method, and the like.

The Cell-ID method is used to determine a position of a wireless AP having the largest signal strength, among peripheral wireless AP information collected by a mobile terminal, as a position of the mobile terminal. The Cell-ID method is an implementation that is minimally complex, does not require additional costs, and location information can be rapidly acquired. However, in the Cell-ID method, the precision of positioning may fall below a desired threshold when the installation density of wireless APs is low.

The fingerprint method is used to collect signal strength information by selecting a reference position from a service area, and to track a position of a mobile terminal using the signal strength information transmitted from the mobile terminal based on the collected information. In order to use the fingerprint method, it is common for the characteristics of radio signals to be pre-stored in the form of a database.

The trigonometry method is used to calculate a position of a mobile terminal based on a distance between coordinates of at least three wireless APs and the mobile terminal. In order to measure the distance between the mobile terminal and the wireless APs, signal strength may be converted into distance information, Time of Arrival (ToA), Time Difference of Arrival (TDoA), Angle of Arrival (AoA), or the like may be taken for transmitted wireless signals.

The landmark method is used to measure a position of a mobile terminal using a known landmark transmitter. In addition to these position location methods, various algorithms may be used to extract (analyze) location information of a mobile terminal Such extracted location information may be transmitted to the mobile terminal 100 through the Wi-Fi location determination server, thereby acquiring location information of the mobile terminal 100.

The mobile terminal 100 can acquire location information by being connected to at least one wireless AP. The number of wireless APs required to acquire location information of the mobile terminal 100 may be variously changed according to a wireless communication environment within which the mobile terminal 100 is positioned.

As previously described with regard to FIG. 1A, the mobile terminal may be configured to include short-range communication techniques such as Bluetooth™ Radio Frequency Identification (RFID), Infrared Data Association (IrDA), Ultra Wideband (UWB), ZigBee, Near Field Communication (NFC), Wireless USB (Wireless Universal Serial Bus), and the like.

A typical NFC module provided at the mobile terminal supports short-range wireless communication, which is a non-contactable type of communication between mobile terminals and generally occurs within about 10 cm. The NFC module may operate in one of a card mode, a reader mode, or a P2P mode. The mobile terminal 100 may further include a security module for storing card information, in order to operate the NFC module in a card mode. The security module may be a physical medium such as Universal Integrated Circuit Card (UICC) (e.g., a Subscriber Identification Module (SIM) or Universal SIM (USIM)), a secure micro SD and a sticker, or a logical medium (e.g., embedded Secure Element (SE)) embedded in the mobile terminal Single Wire Protocol (SWP)-based data exchange may be performed between the NFC module and the security module.

When the NFC module operates in a card mode, the mobile terminal may transmit card information on a general IC card to the outside. More specifically, if a mobile terminal having card information on a payment card (e.g, a credit card or a bus card) approaches a card reader, a short-range mobile payment may be executed. As another example, if a mobile terminal which stores card information on an entrance card approaches an entrance card reader, an entrance approval procedure may start. A card such as a credit card, a traffic card, or an entrance card may be included in the security module in the form of applet, and the security module may store card information on the card mounted therein. Card information for a payment card may include any of a card number, a remaining amount and usage history, and the like. Card information of an entrance card may include any of a user's name, a user's number (e.g., undergraduate number or staff number), an entrance history, and the like.

When the NFC module operates in a reader mode, the mobile terminal can read data from an external tag. The data received from the external tag by the mobile terminal may be coded into the NFC Data Exchange Format defined by the NFC Forum. The NFC Forum generally defines four record types. More specifically, the NFC Forum defines four Record Type Definitions (RTDs) such as smart poster, text, Uniform Resource Identifier (URI), and general control. If the data received from the external tag is a smart poster type, the controller may execute a browser (e.g., Internet browser). If the data received from the external tag is a text type, the controller may execute a text viewer. If the data received from the external tag is a URI type, the controller may execute a browser or originate a call. If the data received from the external tag is a general control type, the controller may execute a proper operation according to control content.

In some cases in which the NFC module operates in a P2P (Peer-to-Peer) mode, the mobile terminal can execute P2P communication with another mobile terminal. In this instance, Logical Link Control Protocol (LLCP) may be applied to the P2P communication. For P2P communication, connection may be generated between the mobile terminal and another mobile terminal. This connection may be categorized as a connectionless mode which ends after one packet is switched, and a connection-oriented mode in which packets are switched consecutively. For a typical P2P communication, data such as an electronic type name card, address information, a digital photo and a URL, a setup parameter for Bluetooth connection, Wi-Fi connection, etc. may be switched. The P2P mode can be effectively utilized in switching data of a small capacity, because an available distance for NFC communication is relatively short.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal.

Control methods according embodiments of the present invention, which can be realized in the mobile terminal configured as described above, are described below referring to the accompanying drawings. It is apparent to those skilled in the art that modification, alteration, and improvement can be made to the present invention within a scope that does not deviate from the nature and gist of the present invention.

The mobile terminal 100 described above is configured to detect a touch input using a pen unit. As the pen unit, there are a stylus pen with which the touch input is applied to a touch screen, a wireless pen configured to transmit a wireless signal to and from the mobile terminal, and the like. The wireless signal is transmitted and received using an ultrasonic wave, a magnetic field, infrared light, or the like. The display unit 151 includes a touch sensor that senses the touch input.

Screen information, which is output to the display unit 151, includes various graphic objects. In this instance, the graphic object is configured to be in the shape of an image, text, an icon, or the like. A home screen page is also referred to an idle screen. If the mobile terminal 100 is in an idle state, it is possible to output the home screen page on the display unit 151. More specifically, an icon of an application installed on the mobile terminal, an icon of a folder or a widget in which the icons are stored, and the like are displayed on the home screen page. At this point, Examples of the graphic object are the icon (thumbnail image), the folder, and the like.

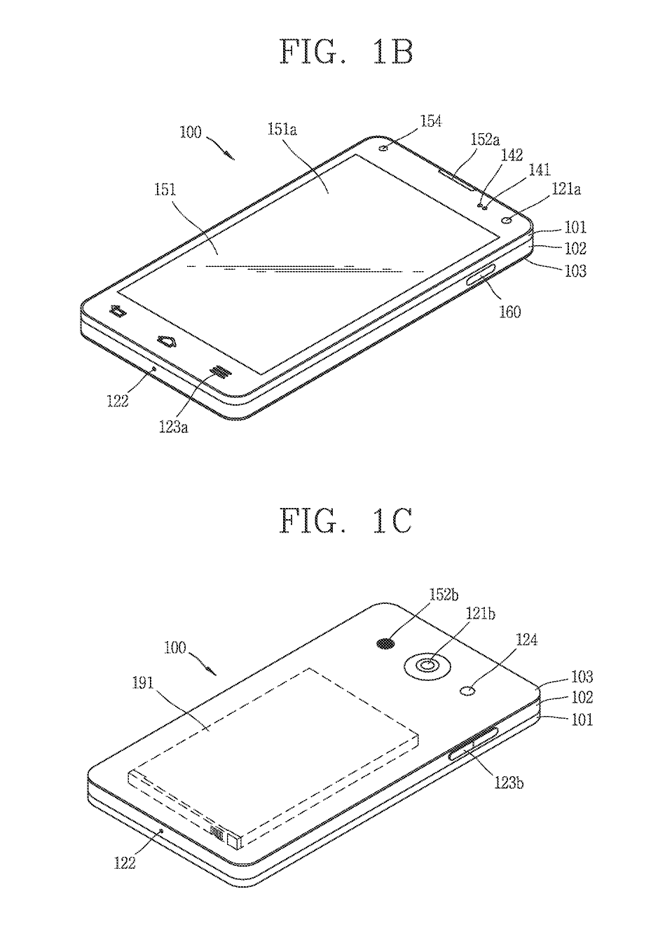

A device for and a method of displaying items of content (for example, thumbnail images of pictures) stored in the folder in an easy, speedy manner are described below. FIG. 2 is a flow chart illustrating a method of controlling the mobile terminal according to the embodiment of the present invention.

First, the controller 180 displays the folder (or an album)) including the items of content (images and photographs) on the display unit 151 in response to a user request (S11). For example, when an application associated with the photograph is selected by the user, the controller 180 displays the folder (or the album) including the images (photographs) on the display unit 151.

When the touch input or a gesture (for example, a long touch, or a touch input in a specific pattern) is sensed as being applied to the folder (or the album) (yes in S12), the controller 180 displays the items of content present within the folder on the folder according to a predetermined pattern on the folder (S13). For example, when the touch input or the gesture (for example, the long touch, or the touch input in the specific pattern) is sensed as being applied to the folder (or the album), the controller 180 displays the items of content present within the folder only on the folder, not on an entire screen of the display unit 151. The predetermined pattern is a pattern for sequentially displaying the items of content present within the folder on the folder, a pattern for randomly displaying the items of content present within the folder on the folder, a pattern for displaying on the folder as many items of content present within the folder as is predefined, or the like.

The specific pattern is set by the user. As an example of this, the specific pattern is set as a pattern that forms a circle, a triangle, a square, and the like, a pattern of squares, a X-shaped pattern, or the like, or as a symbol. As another example, the specific pattern is a pattern that uses text. For example, a letter like “I” written on the graphic object is the specific pattern.

As another example, the specific pattern is set to differ according to a control command. For example, the specific pattern is a pattern that is drawn on a plane of the display unit 151 (or an outside surface of a window covering display elements) to which the screen information is output. In addition, the pattern for termination or execution is a tap on the display unit 151.

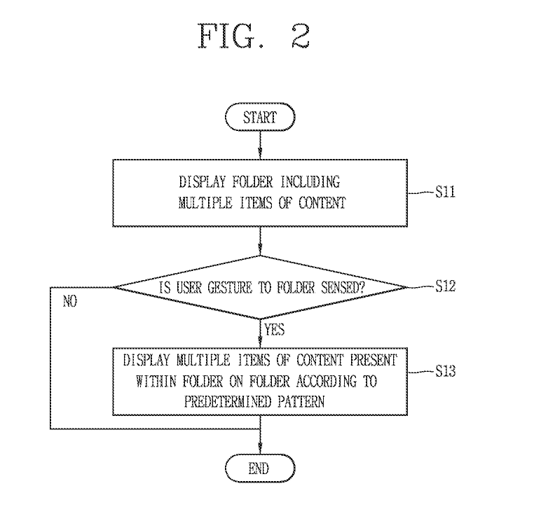

Next, FIG. 3 is a diagram illustrating a method of displaying the content (for example, the thumbnail images corresponding to the photographs) according to the embodiments of the present invention. As illustrated in FIG. 3, during a touch on a folder 3-1 by the user, the controller 180 arranges and displays the images present within the folder 3-1 on the screen of the display unit 151. During the touch on the folder 3-1 by the user, the controller 180, when the images present within the folder 3-1 are successively displayed on the screen of the display unit 151, the controller 180 gradually increases successively arranged images and then gradually decreases the successively arranged images in terms of their size. When the touch on the folder 301 is released, the controller 180 displays only the folder 3-1.

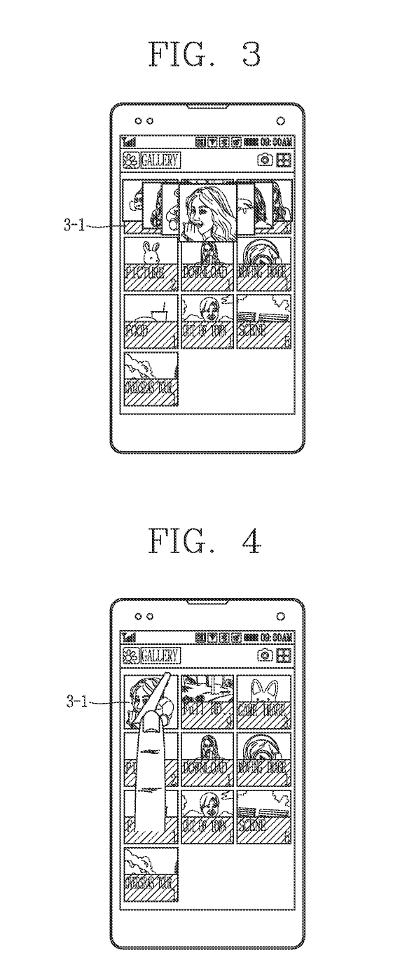

FIG. 4 is a diagram illustrating a method of displaying the content (for example, the thumbnail images corresponding to the photographs) according to the embodiment of the present invention. As illustrated in FIG. 4, each time the folder 3-1 is slide-touched (dragged) by the user, the controller 180 sequentially displays the images present within the folder 3-1 on the folder 301. When the folder 3-1 is slide-touched (dragged) by the user, the controller 180 can increase a size of the folder 3-1 more than that of the adjacent folders until such a slide touch (drag) is released after a predetermined time (for example, ten to twenty seconds) passes. Then, each time the enlarged folder 3-1 is slide-touched (dragged), the controller 180 can sequentially display the images present within the folder 3-1 on the folder 3-1.

Each time the folder 3-1 is slide-touched (dragged) by the user, the controller 180 can display on the folder 3-1 the images present within the folder 3-1 that appear after the images the number of which is predetermined Each time the folder 3-1 is slide-touched (dragged) by the user, the controller 180 can randomly display the images present within the folder 3-1 on the folder 3-1.

When the folder 3-1 is touched on, the controller 180 sequentially displays the images present within the folder 3-1 on the folder 3-1. Then, when many of the same or similar objects (for example, a sea, a person, a tree, and the like) are recognized, the controller 180 determines such images to belong to one group and displays only one of the images within the group. Then, the control may sequentially display the images that appear after the one group, on the folder 3-1.

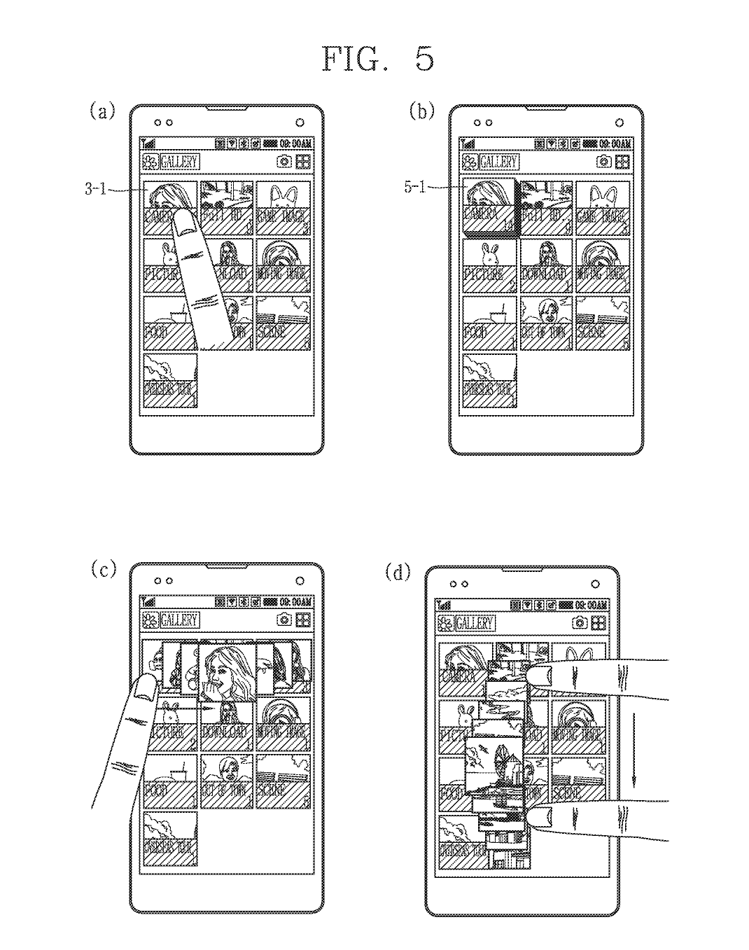

FIGS. 5(a) to 5(d) are diagrams illustrating another method of displaying the content (for example, the thumbnail images corresponding to the photographs) according to the embodiment of the present invention. As illustrated in FIGS. 5(a) and 5(b), when the folder 3-1 is touched on by the user, the controller piles up or stacks the images present within the folder 3-1, one on top of another, as indicated by reference numeral 5-1. For example, when the folder 3-1 is touched on by the user, the controller 180 displays an image showing that the images present within the folder 3-1 are sequentially piled up one on top of another, on the folder 301.

As illustrated in FIGS. 5(c) to 5(d), when the touch input in a specific pattern or the gesture is sensed as being applied to images 5-1 that are piled up on the folder 3-1 one on top of another, the controller 180 arranges the images 5-1 piled up one on top of another, in a direction of the touch input in the specific pattern or of the gesture and moves the arranged images 5-1. For example, when the direction of the touch input in the specific pattern or the direction of the gesture is a left-to-right movement, the controller 180 arranges the images 5-1 piled up one on top of another, in a rightward direction and moves the arranged images 5-1. When the direction of the touch input in the specific pattern or the direction of the gesture is a direction of a top-to-down movement, the controller 180 arranges the images 5-1 piled up one on top of another, in a downward direction and moves the arranged images 5-1.

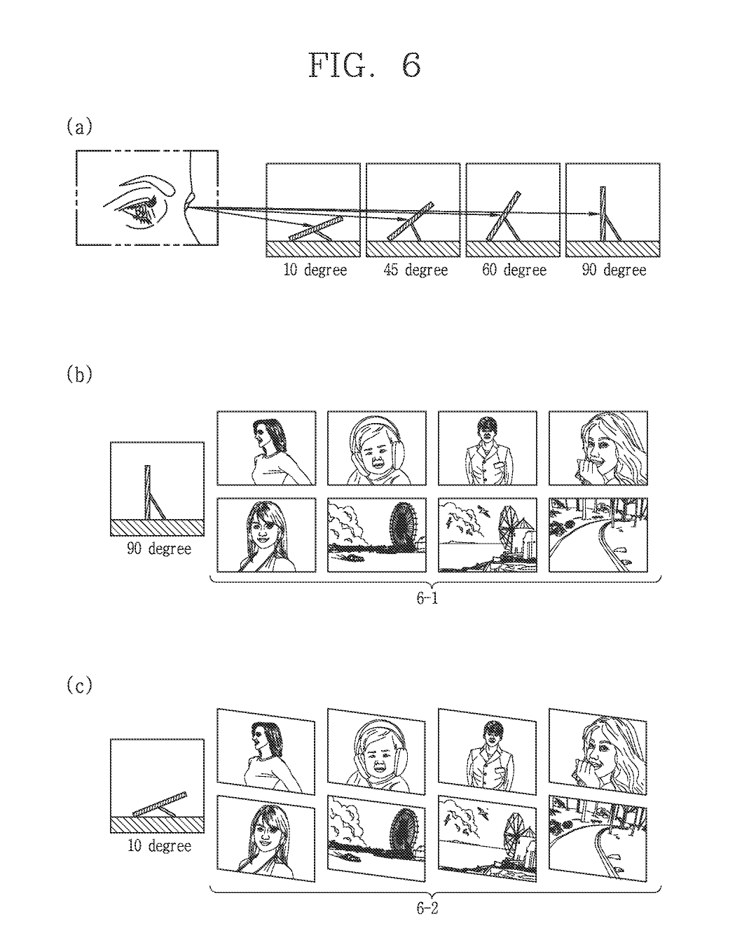

FIGS. 6(a) to 6(c) are diagrams illustrating another method of displaying the content (for example, the thumbnail images corresponding to the photographs) according to the embodiment of the present invention. As illustrated in FIG. 6(a), based on a viewing angle (gaze) for the user, the controller 180 changes inclination of each of the images displayed on the folder 3-1 so the images displayed on the folder 3-1 are matched to the viewing angle. The mobile terminal 100 includes a sensing unit (for example, a camera) that detects the viewing angle for the user. For example, the controller 180 detects user's eyes from an image that is input through the camera 121 and recognizes the viewing angle for the detected user's eyes. The viewing angle differs depending on whether the mobile terminal is put on a flat surface of an object, or depending on the extent to (the angle by) which the mobile terminal is inclined with respect to the flat surface of the object.

As illustrated in FIG. 6(b), when the inclination of the mobile terminal is inclination (for example, an angle of 90 degrees) at which a user's gaze is perpendicular to a front surface of the mobile terminal, images 6-1 displayed on the folder 3-1 are not changed in inclination. In contrast, as illustrated in FIG. 6(c), when the inclination of the mobile terminal is not inclination (for example, an angle of ten degrees) at which the user's gaze is not perpendicular to the front surface of the mobile terminal, the controller 180 changes inclination of each image 6-2 displayed on the folder 3-2, so each image 602 is matched to the user's gaze.

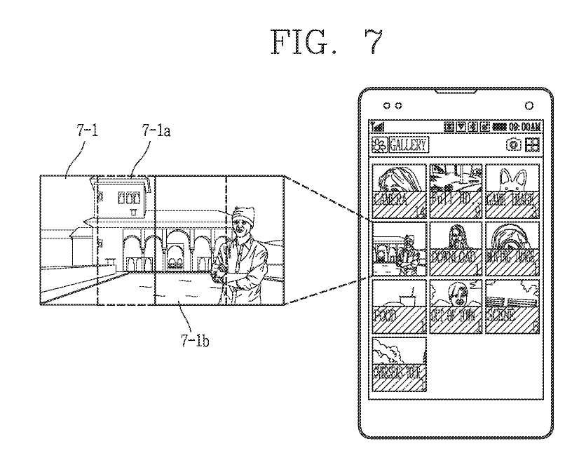

FIG. 7 is a diagram illustrating another method of displaying the content (for example, the thumbnail images corresponding to the photographs) according to the embodiment of the present invention. As illustrated in FIG. 7, when the thumbnail images corresponding to the images present within the folder are generated, the controller 180 does not generate a thumbnail image 7-1a by cutting a portion in the shape of a regular square with a predetermined size out of each image with the center of the portion being consistent with the center of each image.

Instead, the controller 180 generates the thumbnail image by cutting a portion with a predetermined size out of each image with a person (a human face, a human contour, or the like) being in the center of the portion. Thus, the controller 180 displays the generated portion as a thumbnail image 7-1b. For example, when the thumbnail image 7-1a is generated by cutting the portion in the shape of a regular square with the predetermined size out of each image with the center of the portion being consistent with the center of each image, in most cases, the person is not present in the generated thumbnail image 7-la, but present in the image that is cut out of each image. Thus, only with the generated thumbnail image 7-la, the user cannot check whether the image 7-1 is a background photograph or a photograph of the person.

Therefore, in order for the user to check the photograph of the person in an easy, quick manner through the thumbnail image, the controller 180 recognizes the person (for example, the human face, the human contour, or the like) in each image 7-1 and generates the thumbnail image by cutting a portion with a predetermined size out of each image with the recognized person (for example, the human face, the human contour, or the like) being in the center of the portion. Thus, the controller 180 displays the generated portion as the thumbnail image 7-1b.

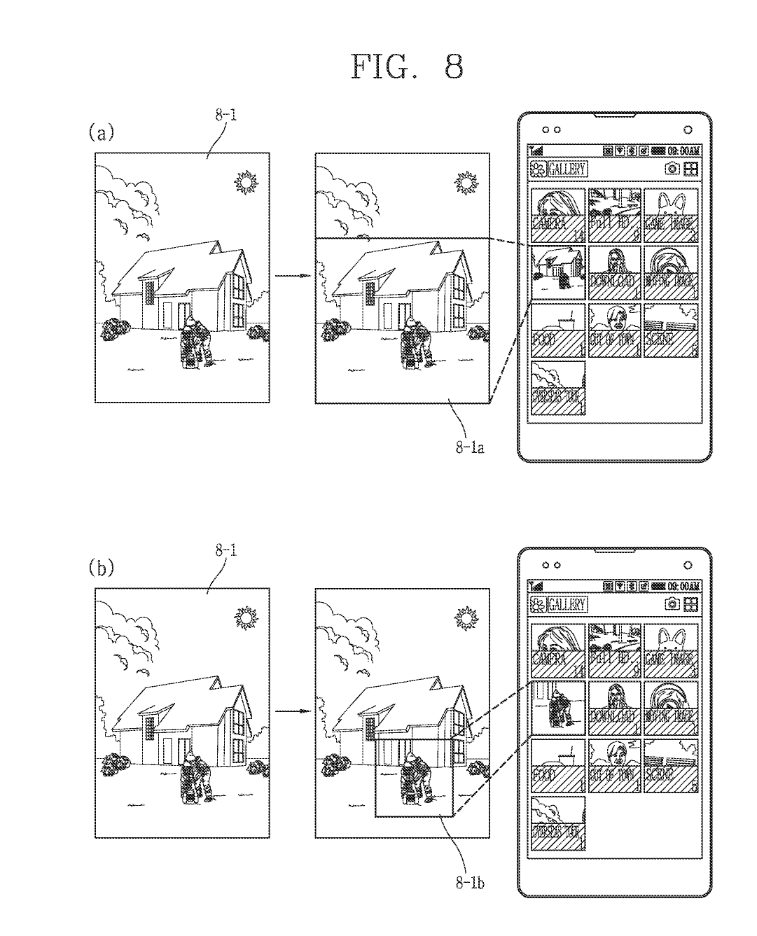

FIGS. 8(a) and 8(b) are diagrams illustrating another method of displaying the content (for example, the thumbnail images corresponding to the photographs) according to the embodiment of the present invention. As illustrated in FIG. 8(a), when the thumbnail images corresponding to the images (photographs) within the folder are generated, the controller 180 generates the thumbnail image 8-1a by cutting a portion with a predetermined size out of each image 8-1 with the person (the human face, the human contour, or the like) in each image 8-1 being in the center of the portion and displays the generated image 8-la. In such a case, an area corresponding to the person (the human face, the human contour, or the like) is so small that it may be difficult for the user to check the person (the human face, the human contour, or the like).

Therefore, as illustrated in FIG. 8(b), when the thumbnail images corresponding to the images (photographs) within the folder are generated, the controller 180 recognizes a person area (the human face, the human contour, or the like) in each image 8-1. Then, when the recognized person area is reduced more than a predetermined area (for example, the thumbnail image), the controller 180 enlarges the recognized person area so the recognized person area is equal in size to the predetermined area. Then, the controller 180 generates the enlarged person area as the thumbnail image and displays the generated thumbnail image 8-1b.

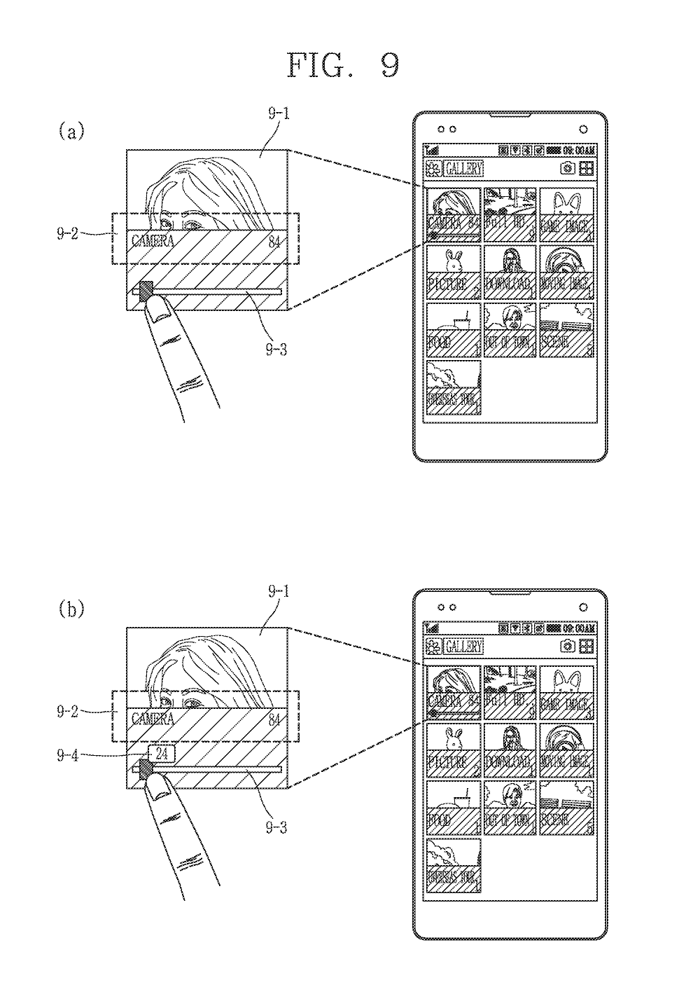

FIG. 9(a) is a diagram illustrating another method of displaying the content (for example, the thumbnail images corresponding to the photographs) according to the embodiment of the present invention. As illustrated in FIG. 9(a), the controller 180 can display both information on an apparatus (for example, the camera) or a method (for example, downloading) that captured or obtained each of the images within a folder 9-1, respectively, and the number 9-2 of the images present within the folder 9-1 on the folder 9-2. Moreover, the controller 180 can further display on the folder 9-1 a scroll bar 9-3 for sequentially displaying the images present within the folder 9-1. As the scroll bar 9-3 is moved (scrolled) by the user's touch input, the controller 180 sequentially displays the images present within the folder 9-1 on the folder 9-1. The user sets the order in which the images present within the folder 9-1 are displayed based on time, place, or the like. When the user selects any one from among the images displayed on the folder 9-1 (for example, when the user applies the long touch to any one form among the images displayed on the folder 9-1), the controller 180 can display a photograph corresponding to the selected image, or may open the folder 9-1 and highlight the selected image (for example, marks the selected image with a box, makes the selected image twinkle, or the like).

As illustrated in FIG. 9(b), the controller 180 displays on the folder 9-1 a scroll bar 9-3 for sequentially or randomly displaying the images present within the folder 9-1 on the folder 9-1, and furthermore, displays information (for example, an icon indicating image's turn in display) 9-4 indicating turn of the image displayed currently on the folder 9-1 in display, on the scroll bar 9-3.

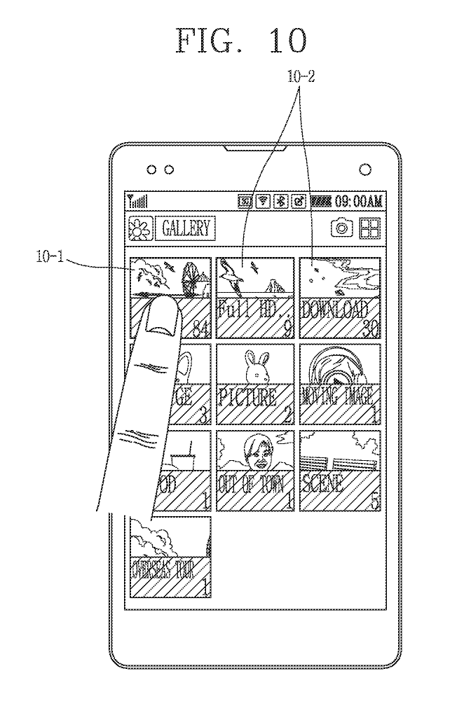

FIG. 10 is a diagram illustrating another method of displaying the content (for example, the thumbnail images corresponding to the photographs) according to the embodiment of the present invention. As illustrated in FIG. 10, the touch input is sensed as being applied to the folder 10-1, the controller 180 sequentially displays the images present within a folder 10-1 on the folder 10-1 and at the same time, displays the images present within a folder 10-2 adjacent to the folder 10-1 on the folder 10-2, in an automatic, sequential manner. Thus, with one touch input, the controller 180 sequentially displays the images with the multiple folders on the folders. Therefore, the user can check the images displayed on the multiple folders at the same time.

If the touch input in a specific pattern is sensed as being applied to the folder 10-1, when the images present within the folder 10-1 are sequentially displayed on the folder 10-1, the controller 180 searches the images within the adjacent folder 10-2 for an image that is matched to or similar to the image which is currently displayed on the folder 10-1 and displays the searched-for image on the folder 10-2.

For example, the controller 180 searches the images within the adjacent folder 10-2 for an image that corresponds to a place which is matched to or similar in appearance to the place where the image currently displayed on the folder 10-1 is captured, and displays the searched-for image on the folder 10-2. The controller 180 searches the images within the adjacent folder 10-2 for an image that corresponds to image capture time which is matched to the time when the image currently displayed on the folder 10-1 is captured, or which is somewhat earlier or later than the time when the image currently displayed on the folder 10-1 is captured, and displays the searched-for image on the folder 10-2.

The controller 180 searches the images within the adjacent folder 10-2 for an image that corresponds to a person that is matched to or similar to the person in the image (for example, a photograph of a person, a photograph of a group of persons) displayed currently on the folder 10-1, and displays the searched-for image on the folder 10-2. The controller 180 searches the images within the adjacent folder 10-2 for an image that corresponds to a scene which is matched to or similar to the scene (for example, a mountain, sea, a building, or the like) in the image displayed currently on the folder 10-1, and displays the searched-for image on the folder 10-2.

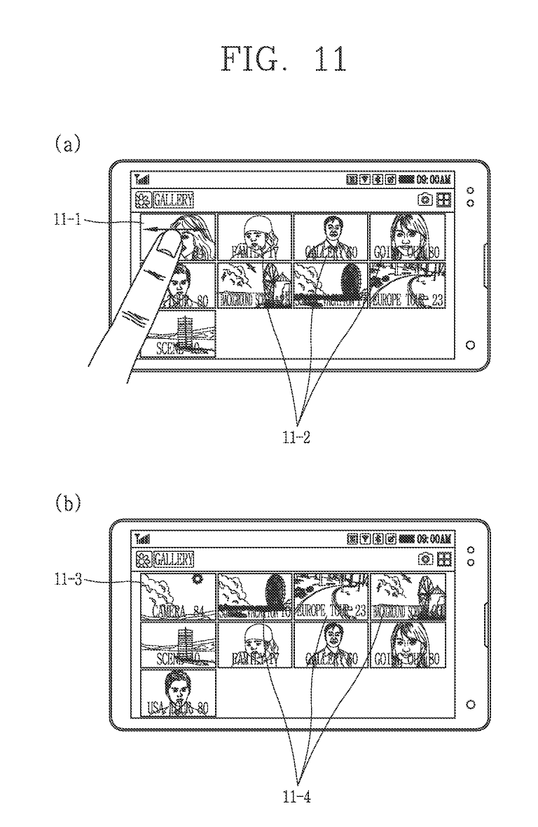

FIG. 11(a) is a diagram illustrating another method of displaying the content (for example, the thumbnail images corresponding to the photographs) according to the embodiment of the present invention. As illustrated in FIG. 11(a), when images present within the folder 11-1 are sequentially displayed on the folder 11-1 each time the touch input in a specific pattern is sensed as being applied to the folder 11-1, the controller 180 arranges the folders adjacent to the folder 11-1, in order of decreasing the number of images each of which is matched to or similar to an image currently displayed on the folder 11-1 and displays the arranged folders, and thus the user can quickly check the image matched to or similar to the image currently displayed on the folder 11-1 because the folders are arranged.

For example, when the images present within the folder 11-1 are sequentially displayed on the folder 11-1 each time the touch input in a specific pattern is sensed as being applied to the folder 11-1, the controller 180 arranges folders 11-2 adjacent to the folder 11-1, in order of decreasing the number of person images each of which is matched to or similar to a person image currently displayed on the folder 11-1, and displays the arranged folders 11-2.

As illustrated in FIG. 11(b), when the images present within the folder 11-3 are sequentially displayed on the folder 11-3 each time the touch input in a specific pattern is sensed as being applied to the folder 11-3, the controller 180 arranges folders 11-4 adjacent to the folder 11-3, for display in increasing order of an image of the person matched to or similar to a scene image currently displayed on the folder 11-3.

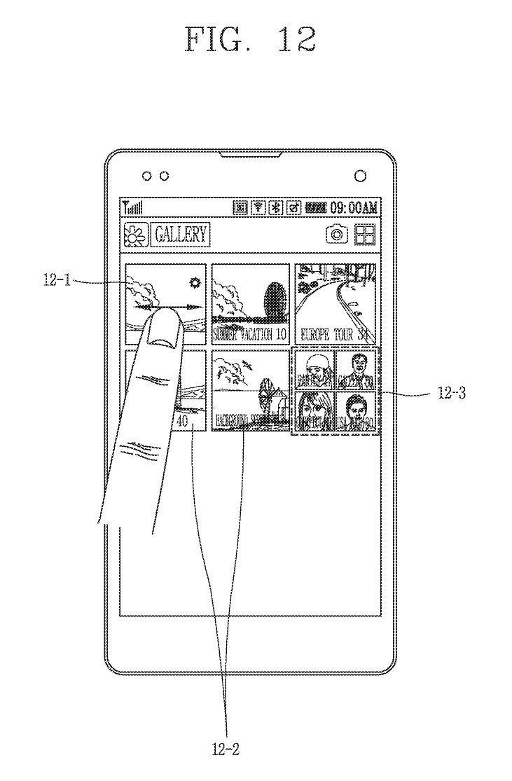

FIG. 12 is a diagram illustrating another method of displaying the content (for example, the thumbnail images corresponding to the photographs) according to the embodiment of the present invention. As illustrated in FIG. 12, when images present within the folder 12-1 are sequentially displayed on the folder 12-1 each time the touch input in a specific pattern is sensed as being applied to the folder 12-1, the controller 180 arranges first adjacent folders 12-2, each of which includes an image that is matched to or similar to the image currently displayed on the folder 12-1, among the folders adjacent to the folder 12-1, so the first adjacent folders 12-2 are adjacent to the folder 12-1, and at the same time, enlarges the first adjacent folders 12-2 and reduces second adjacent folders 12-3, each of which includes an image that is non-matched to or non-similar to the image currently displayed on the folder 12-1. As a result, the user can quickly check the folders including the image that is matched to or similar to the image currently displayed on the folder 12-1.

For example, when images present within the folder 12-1 are sequentially displayed on the folder 12-1 each time the touch input in a specific pattern is sensed as being applied to the folder 12-1, the controller 180 arranges the first adjacent folders 12-2, each of which includes the scene image that is matched to or similar to the scene image currently displayed on the folder 12-1, among the folders adjacent to the folder 12-1, so the first adjacent folders 12-2 are adjacent to the folder 12-1, and at the same time, enlarges the first adjacent folders 12-2 and reduces the second adjacent folders 12-3, each of which includes a person image that is non-matched to or non-similar to the scene image currently displayed on the folder 12-1.

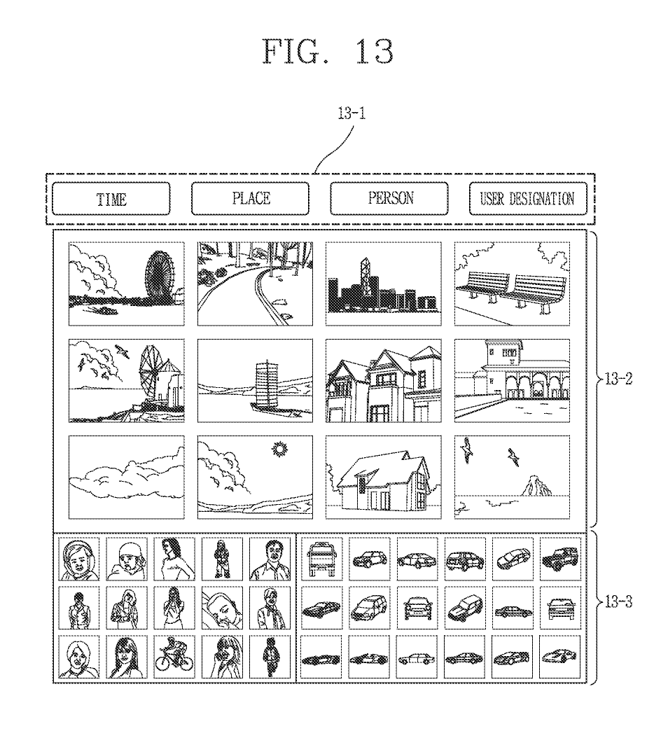

FIG. 13 is a diagram illustrating another method of displaying the content (for example, the thumbnail images corresponding to the photographs) according to the embodiment of the present invention. As illustrated in FIG. 13, when the touch input in a specific pattern is sensed as being applied to the folder 12-1, the controller 180 displays the images present within the folder 12-1 on the entire screen of the display unit 151, and at the same time, displays menus 13-1 together for arranging the images. The menus 13-1 may include a time, a place, a person, a scene, a user designation, and the like.

When a time menu is selected, the controller 180 arranges the images in chronological order, displays the arranged images on a first display region 13-2 of the display unit 151, displays the images that do not contain the time information, on a second display region 13-3 of the display unit 151, and enlarges the images displayed on the first display region 13-2 more greatly more than the images displayed on the second display region 13-3 and displays the enlarged images.

When a place menu is selected, the controller 180 arranges the images depending on whether the places are the same in appearance or in order of decreasing the degree to which the places are similar in appearance to one another, display the arranged images on the first display region 13-2 of the display unit 151, displays the images that do not contain the place information, on the second display region 13-3 of the display unit 151, and enlarges the images display displayed on the first display region 13-2 more greatly than the image displayed on the second display region 13-3 and displays the enlarged images.

When a person menu is selected, the controller 180 arranges the images depending on whether the persons are the same or in order of decreasing the degree to which the places are similar to one another, display the arranged images on the first display region 13-2 of the display unit 151, displays the images that do not contain the same or similar person, on the second display region 13-3 of the display unit 151, and enlarges the images display displayed on the first display region 13-2 more than the image displayed on the second display region 13-3 and displays the enlarged images.

The controller 180 displays a calendar on the display unit 151 according to a user's request. When a photograph icon displayed along with the calendar is selected by the user, the controller 180 activates a date on which the images are captured, among dates in the calendar, based on image capture information (for example, an image capture date, image capture time, and the like) on the images (photographs) within the folder.

When year information (for example, the year 2013) in the calendar is selected, the controller 180 activates the dates on which the images were captured, among the dates in the calendar corresponding to the year information. When any date is selected from among the dates (activated dates) on which the images were captured, the controller 180 can display the image(s) that was (were) captured on the selected date, on the display unit 151.

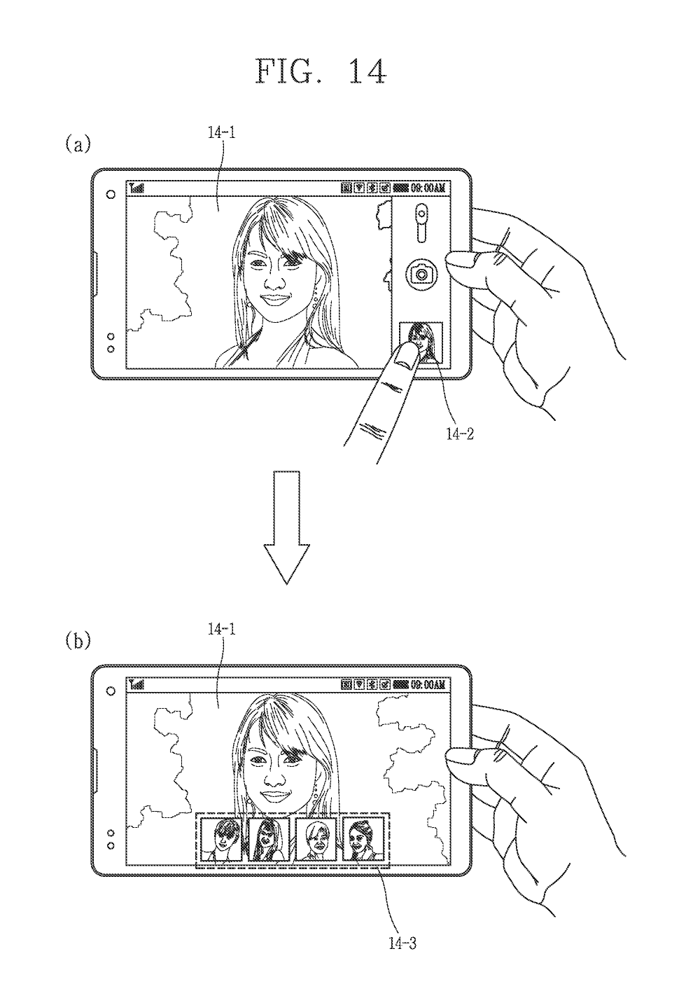

Next, FIGS. 14(a) and 14(b) are diagrams illustrating another method of displaying the content (for example, the thumbnail images corresponding to the photographs) according to the embodiment of the present invention. As is illustrated in FIGS. 14(a) and 14(b), when an image 14-1 is captured by a first camera 121 installed on a front side of a contour of the mobile terminal, the controller 180 searches the folder for the images captured by the first camera 121a, and displays searched-for images 14-3 on the display unit 151 along with the captured image 14-1.

When the user selects a thumbnail image 14-2 that is displayed after the image 14-1 is captured by a first camera 121 installed on the front side of the contour of the mobile terminal, the controller 180 searches the folder for the images captured by the first camera 121a, and may display the searched-for images 14-3 on the display unit 151 along with the captured image 14-1 along with the captured image 14-1.

When the image 14-1 is captured by a second camera 121b installed on a rear surface of the contour of the mobile terminal, the controller 180 searches the folder for the images captured by the second camera 121b, and displays the searched-for images 14-3 on the display unit 151 along with the captured image 14-1.

Because in most cases, the front side camera (first camera) 121a is used as a camera that captures the user himself/herself, if the folder (gallery) is entered in order to check the photograph taken with the front side camera 121a, the controller automatically sorts the images appearing within the folder by the photograph taken with the front surface camera 121a, and displays the result of the sorting.

If the folder (gallery) is entered in order to check the photograph taken with the rear surface camera (the second camera), the controller 180 automatically sorts the images appearing within the folder by the photograph taken with the rear surface camera 121b and displays the result of the sorting. If the folder (gallery) is entered in order to check a panoramic photograph taken with the front surface camera (the first camera) 121a or the rear surface camera (the second camera) 121b, the controller 180 automatically sorts the images appearing within the folder by the panoramic photograph taken with the front surface camera (the first camera) 121a or the rear surface camera 121b and displays the result of the sorting.

If the folder (gallery) is entered in order to check a moving image taken with the front surface camera (the first camera) 121a or the rear surface (the second camera) 121b, the controller 180 automatically sorts the images appearing within the folder by the moving image taken with the front surface camera (the first camera) 121a or the rear surface camera 121b.

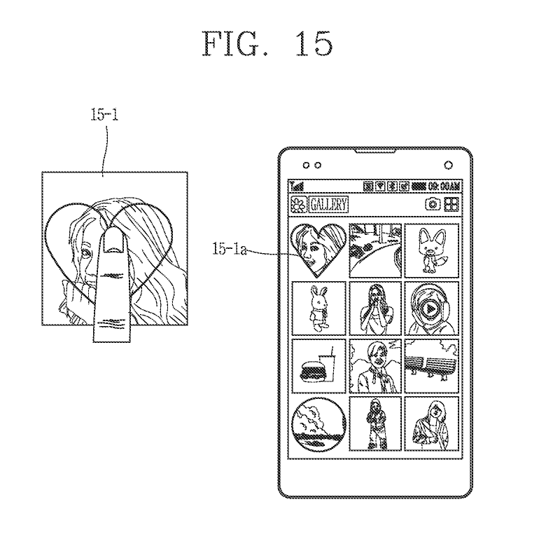

FIG. 15 is a diagram illustrating another method of displaying the content (for example, the thumbnail images corresponding to the photographs) according to the embodiment of the present invention. As illustrated in FIG. 15, when the thumbnail images corresponding to the images present within the folder are generated, if a specific shape (for example, a heart shape, a circle shape, a triangle shape, or the like) is drawn on a specific image 15-1 with the touch input in the specific pattern, the controller 180 changes a shape of the specific image 15-1 into the specific shape and displays the image in the changed shape as a thumbnail image 15-1a.

When the thumbnail images corresponding to the images present within the folder are generated, if a specific shape (for example, the heart shape, the circle shape, the triangle shape, or the like) is drawn on the person image with the touch input in a specific pattern, the controller 180 changes the shape of the person image into the specific pattern, and displays the image in the changed shape as the thumbnail image 15-1a.

When the shape of the person image is changed into the specific shape (for example, the heart shape), and the image in the changed shape is displayed as the thumbnail image 15-1a, the controller 180 searches the images present within the folder for the person image, and may automatically change the shapes of the searched-for person images into the specific shape (for example, the heart shape).

The controller 180 can automatically change the shapes of the images with the first resolution (for example, 480×800) into a first shape (for example, the circle shape). The controller 180 can automatically change the shapes of the images with second resolution (for example, 800×600) into a second shape (for example, the circuit shape). The shapes of the images, which are different in the resolution, are changed differently, and thus the user can check the images with the desired resolution, in an easy, quick manner.

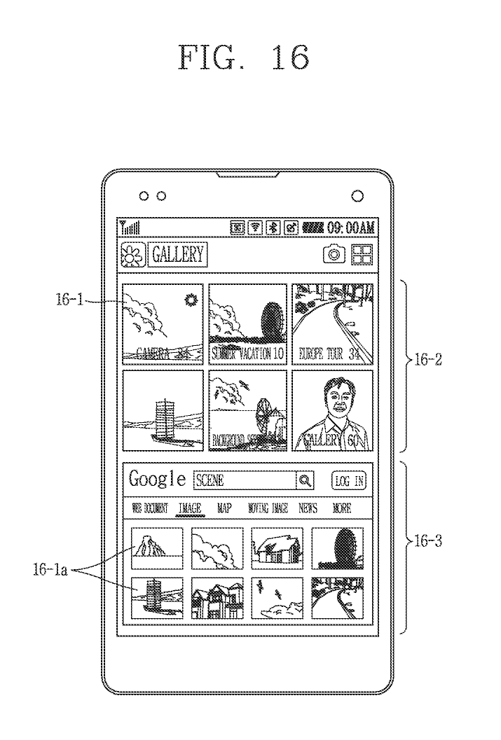

FIG. 16 is a diagram illustrating another method of displaying the content (for example, the thumbnail images corresponding to the photographs) according to the embodiment of the present invention. As illustrated in FIG. 16, when the touch input in a specific pattern is sensed as being applied to the folder 16-1, the controller 180 displays the images present within the folder 16-1 sequentially. At the same time, the controller 180 executes a web application program (for example, an image-based search application program (a Google image search application program, Facebook, and the like)), searches for an image that is matched (or associated) with the image currently displayed on the folder 16-1, through the web application program, and displays the searched-for image on the display unit 151.

For example, the controller 180 displays the folders on a first display region 16-2 of the display unit 151, and displays the images searched for through the web application program on a second display region 16-3 of the display unit 151. When the touch input in a specific pattern is sensed as being applied to the folder 16-1, the controller 180 automatically executes the web application program, and thus searches for the image matched with the image currently displayed on the folder 16-1 and displays the searched-for image on the display unit 151.

When the touch input in a specific pattern is sensed as being applied to the folder 16-1, the controller 180 automatically executes the web application program, and thus searches for an image or a document matched with the image capture information (for example, the image capture place, the image capture time, and the like) on the image currently displayed on the folder 16-1, and may display the searched-for image or document on the display unit 151.

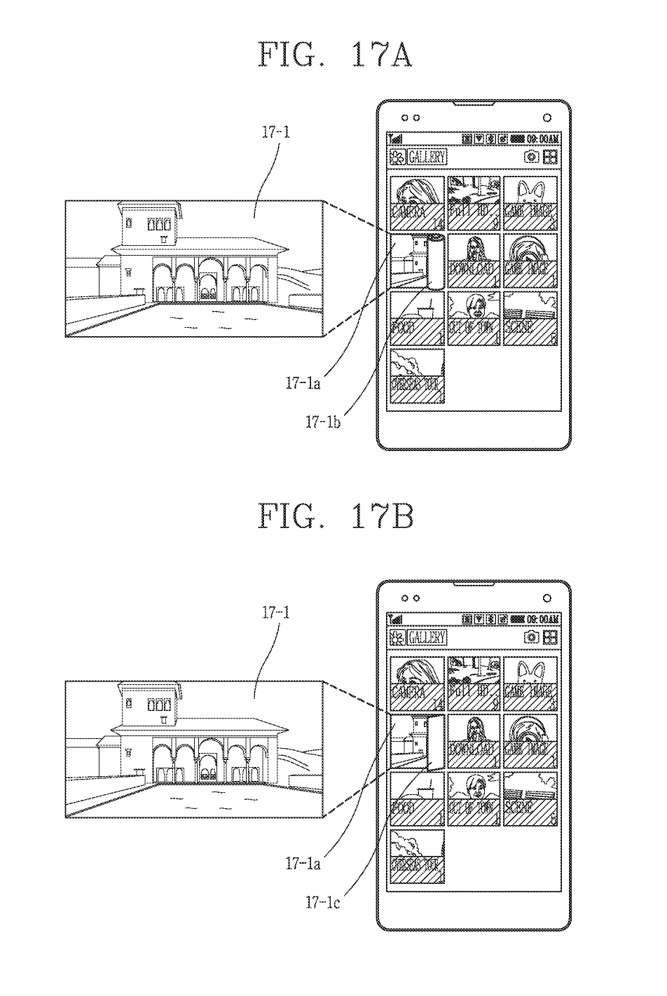

FIGS. 17A and 17B are diagrams illustrating another method of displaying the content (for example, the thumbnail images corresponding to the photographs) according to the embodiment of the present invention. As illustrated in FIGS. 17A and 17B, when the images (thumbnail images) present within the folder is displayed on the folder, if an image 17-1a currently displayed on the folder is a panoramic image 17-1, the controller 180 displays a sub-image 17-1b indicating that the image (panoramic image) 17-1a currently displayed on the folder is the panoramic image 17-1, on the currently displayed image 17-1a. The sub-image 17-1b indicating that the image (panoramic image) 17-1a is the panoramic image 17-1 may be an image 17-1b rolled into the shape of a tube or an image 17-1c a portion of which is folded.

When the sub-image 17-1b indicating that the image (panoramic image) 17-1a is the panoramic image 17-1 is touched on by the user, or the touch input is sensed as being applied to the currently displayed image 17-1a, the controller 180 displays the image (one covered portion of the panoramic image) that is covered by the image 17-b rolled in the shape of a tube or the image 17-1c the portion of which is folded, and thus the user can check the entire panoramic image 17-1.

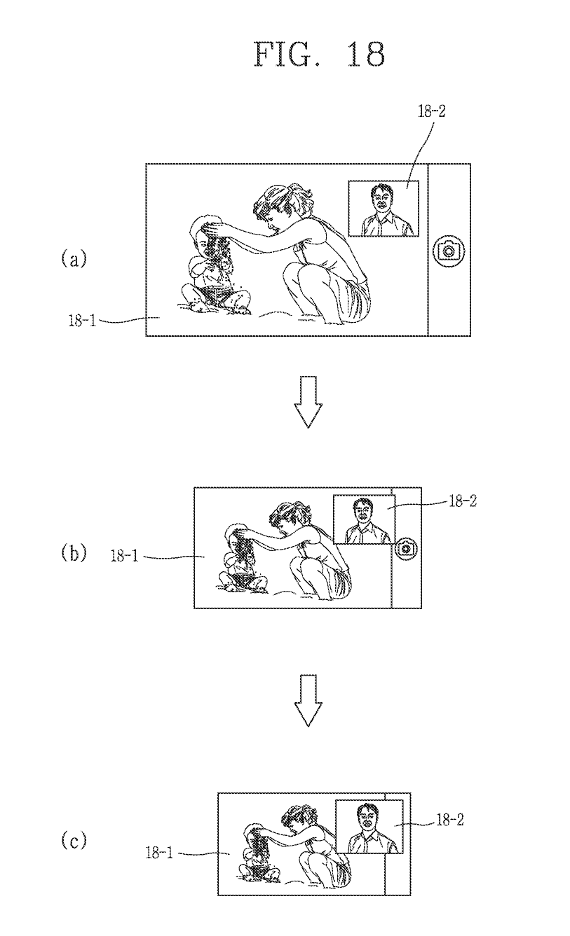

FIGS. 18(a) to 18(c) are diagrams illustrating another method of displaying the content (for example, the thumbnail images corresponding to the photographs) according to the embodiment of the present invention. As illustrated in FIGS. 18(a) to 18(c), the controller 180 combines into one image two images (for example, a first image 18-1 captured by the rear surface camera (the second camera) 121b and a second image 18-2 captured by the front surface camera (the first camera) 121a) that are captured at the same time by the front surface camera (the first camera) 121a and the rear surface camera (the second camera) 121b, and displays the result of the combination on the display unit 151. The front surface camera (the first camera) 121a has low resolution, and the rear surface camera (the second camera) 121b has high resolution.

For example, the one image that results from the combination is converted into the thumbnail image. Then, when the thumbnail image that results from the conversion is displayed on the folder, the second image 18-2 captured by the front surface camera 121a is displayed in a relatively small size, compared with the first image 18-1, because the second image 18-2 is captured by the front surface camera (the first camera) 121a with low resolution. Therefore, each time the one image that results from the combination is enlarged with the touch input (pinch in) by the user, the controller 180 gradually decreases a scale-down ratio of the second image 18-2 in the one image that results from the combination, to a smaller degree than that of the first image 18-1. Thus, the user can easily check not only the first image 18-1 in the one image that results from the combination, but also the second image 18-2. That is, each time the displayed combination-resulting image is reduced, the controller 180 makes the scale-down ratio of the first image 18-1 in the combination-resulting image differ from the scale-down ratio of the second image 18-2.

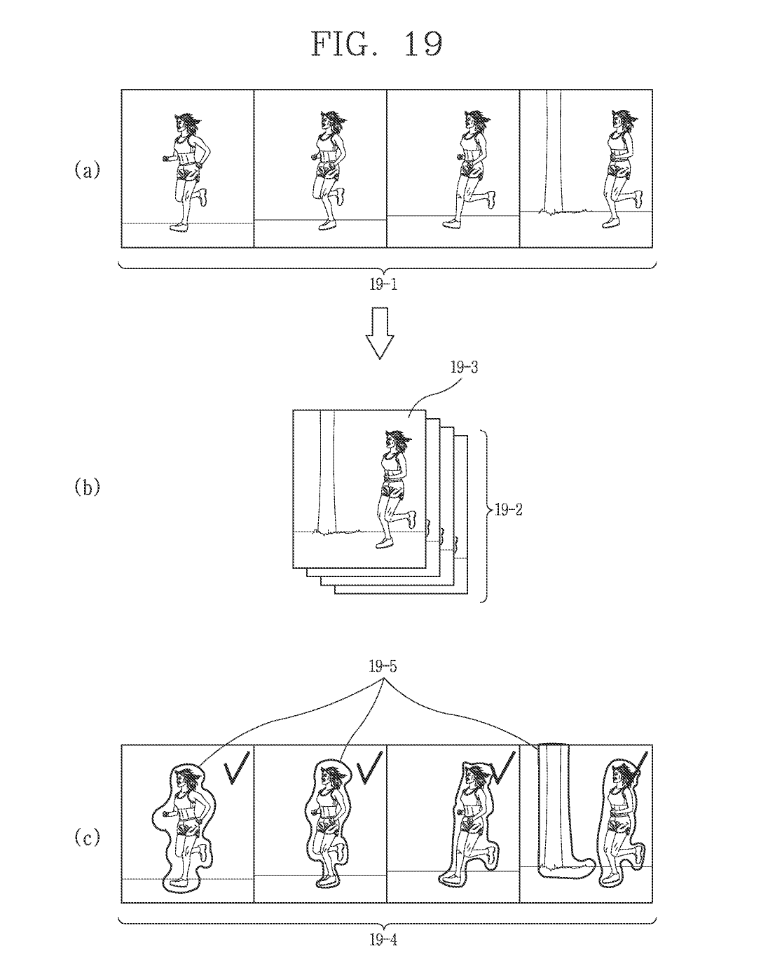

FIGS. 19(a) to 19(c) are diagrams illustrating another method of displaying the content (for example, the thumbnail images corresponding to the photographs) according to the embodiment of the present invention. As illustrated in FIGS. 19(a) to 19(b), when the images present within the folder are displayed on the folder, the controller 180 searches the images present within the folder for successively captured images (for example, images that are successively captured for a given time on the same date) 19-1 or recognizes the successively captured images from the images present within the folder. Then, the controller 180 piles up the searched-for images 19-1 one on top of another (forms sequentially piled-up images), and displays the result of the piling up, on the folder. Then, the controller 180 displays the piled-up images 19-2 successively below the uppermost image (representative image) 19-3. Thus, a moving image effect is provided. For example, when successively captured 20 images (photographs) are individually displayed on the folder, this increases the number of images that are displayed on the folder, taking up more space inefficiently. Therefore, when the images present within the folder are displayed on the folder, if the successively captured images (for example, the images that are successively captured for a given time on the same date) 19-1 are present within the folder, the controller 180 displays only the image representing the successively captured images on the folder.

As illustrated in FIG. 19(c), when the uppermost image (representative image) 19-3 is selected (for example, when a long touch is applied to the uppermost image 19-3), the controller 18 arranges the piled-up images 19-2 in a horizontal or vertical direction and displays the arranged piled-up images 19-2. Then, the controller 18 detects spatial differences between the arranged images 19-4 and displays information (for example, a line, a color, a symbol, a letter, or the like that indicates the detected spatial difference) indicating the detected spatial difference on each of the arranged images 19-4.

When any one among the successively captured images is enlarged or reduced, the controller 180 can enlarge or reduce the rest of the successively captured images at the same time.

The foregoing embodiments and advantages are merely and are not to be considered as limiting the present invention. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the embodiments described herein may be combined in various ways to obtain additional and/or alternative embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal, comprising:
a wireless communication unit configured to provide wireless communication;
a display unit configured to display a folder including multiple images; and
a controller configured to:
receive a touch input having a specific pattern applied to the folder, and
display images present within the folder on the folder according to a predetermined display pattern associated with the touch input applied to the folder.

2. The mobile terminal of claim 1, wherein the controller is configured to successively display the images present within the folder on a screen of the display unit only while the touch input is being applied to the folder, and
wherein the successively displayed images are first gradually enlarged and then are gradually reduced.

3. The mobile terminal of claim 1, wherein the controller is configured to enlarge the folder while the touch input is applied to the folder for a predetermined time and sequentially display the images present within the folder on the folder each time the touch input is being applied to the enlarged folder.

4. The mobile terminal of claim 1, wherein the controller is configured to stack the images present within the folder and display the stacked images on the folder when the touch input is being applied to the folder, and
wherein, when a subsequent touch input having another specific pattern or a gesture is being applied to the stacked images, the controller rearranges the stacked images in a direction in which the touch input in said another specific pattern or the gesture is applied to the stacked images and moves the stacked images to spread out along said direction.

5. The mobile terminal of claim 1, further comprising a sensing unit configured to sense a user's gaze,
wherein the controller is configured to change inclinations of the images arranged on the folder so the images displayed on the folder are matched with the angle of the user's gaze with respect to the mobile terminal.

6. The mobile terminal of claim 1, wherein each of the displayed images is represented as a thumbnail image, and
wherein the controller is configured to recognize whether a human face or a human contour is present in each of the multiple images present within the folder, and to cut each image to a predetermined size based on the recognized human face or human contour to generate the thumbnail image.

7. The mobile terminal of claim 1, wherein each of the displayed images is represented as a thumbnail image, and
wherein the controller is configured to recognize whether a human face or a human contour is present in each of the multiple images present within the folder, and to enlarge an area corresponding to the recognized human face or human contour such that that the enlarged region becomes the thumbnail image.

8. The mobile terminal of claim 1, wherein, when the images present within the folder are sequentially displayed on the folder, the controller is configured to recognize which images present within the folder have a same or similar object, to classify the recognized images as one group, to display only one image selected from the one group on the folder, and then to sequentially display on the folder the images that appear after the one group.

9. The mobile terminal of claim 8, wherein the controller is configured to display a scroll bar on the folder, and to sequentially display the images present within the folder on the folder as the scroll bar is scrolled.

10. The mobile terminal of claim 9, wherein the controller is configured to display information indicating the total number of multiple images in the folder and to display, on the scroll bar, the position of the image currently displayed on the folder with respect to the total number of multiple images in the folder.

11. The mobile terminal of claim 1, wherein, when the touch input in the specific pattern is being applied to the folder, the controller is configured to sequentially display the images present within the folder on the folder and, at the same time, to sequentially display images present within an adjacent folder to the folder on the adjacent folder.

12. The mobile terminal of claim 11, wherein, when the touch input in the specific pattern is being applied to the folder when the images within the folder are sequentially displayed on the folder, the controller is configured to search the images present within the adjacent folder for an image that is matched to or similar to the image currently displayed on the folder.

13. The mobile terminal of claim 11, wherein, when the touch input in the specific pattern is being applied to the folder when the images within the folder are sequentially displayed on the folder, the controller is configured to determine the number of images in all adjacent folders that are matched to or similar to the image currently displayed on the folder and to arrange all adjacent folders in order of decreasing number of images matched to or similar to the image currently displayed on the folder and to display the arranged adjacent folders.

14. The mobile terminal of claim 1, wherein the controller is configured to:
determine among adjacent folders a set of first adjacent folders, each of which includes an image that is matched to or similar to the image currently displayed on the folder, and a set of second adjacent folders, each of which does not include an image that is matched to or similar to the image currently displayed on the folder, and
arrange the first adjacent folders to be closer to the folder than the second adjacent folders and to enlarge the first adjacent folders and reduce the second adjacent folders.

15. The mobile terminal of claim 1, wherein, when a first image is captured by a first camera, the controller is configured to search the folder for the first images captured by the first camera, and to display the searched-for first images on the display unit along with the captured first image, and
wherein, when a second image is captured by a second camera, the controller is configured to search the folder for the second images captured by the second camera, and to display the searched-for second images on the display unit along with the captured second image, and
wherein the first camera and the second camera are different from each other.

16. The mobile terminal of claim 1, wherein, when a specific shape is drawn with the touch input in the specific pattern, the controller is configured to change a shape of the displayed image into the specific shape, and to display the image in the changed shape as a thumbnail image.

17. The mobile terminal of claim 16, wherein the controller is configured to search the folder for images that are matched to the displayed image, and to change shapes of the searched-for images into the specific shape.

18. The mobile terminal of claim 1, wherein, when the touch input in the specific pattern is being applied to the folder, the controller is configured to execute a web application program, to search for an image associated with the image currently displayed on the folder through the web application program, and to display the searched-for image along with the currently displayed image.

19. The mobile terminal of claim 1, wherein, when the image currently displayed on the folder is a panoramic image, the controller is configured to display on the currently displayed image a sub-image indicating that the currently displayed image is the panoramic image.

20. The mobile terminal of claim 19, wherein, when the sub-image is selected, the controller is configured to display a portion of the panoramic image covered by the sub-image.

21. The mobile terminal of claim 19, wherein the controller is configured to capture a first image using a first camera and, at the same time, capture a second image using a second camera, to combine the first and second images captured at the same time into one image, and to display the one image that results from the combination on the display unit,
wherein, when the touch input in the specific pattern is sensed as being applied to the folder, the controller is configured to change the displayed one image such that ratio of the first image to the one image and the ratio of the second image to the one image are changed, and
wherein the first camera and the second camera are different from each other.

22. The mobile terminal of claim 1, wherein, when the folder is searched for successively captured images when the images present within the folder are displayed on the folder, the controller is configured to select a representative image from among the successively captured images and to display only the representative image on the folder.

23. The mobile terminal of claim 22, wherein the controller is configured to successively display the successively captured images on the representative image such that a moving image is displayed on the representative image.

24. The mobile terminal of claim 23, wherein, when the representative image is selected, the controller is configured to arrange the successively captured images in a horizontal or vertical direction, to display the arranged images, to detect spatial differences between the arranged images, and to display information indicating the detected spatial difference on each of the arranged images.
